(19) United States
(12) Patent Application Publication
(10) Pub. No.: US 2014/0182209 A1
(43) Pub. Date: Jul. 3, 2014

(54) PORT ASSEMBLY FOR SELECTIVE INSERTION OF OBJECTS INTO A WELL

(71) Applicant: QUALITROL COMPANY, LLC, Fairport, NY (US)

(72) Inventor: Joshua J. Herz, Rochester, NY (US)

(73) Assignee: Qualitrol Company, LLC, Fairport, NY (US)

(21) Appl. No.: 13/731,799

(22) Filed: Dec. 31, 2012

(51) Int. Cl. E06B 7/18

(52) U.S. Cl. CPC E06B 7/18
USPC 49/373; 49/480.1

(57) ABSTRACT

A port assembly is receivable in an opening allowing access to the interior of a transformer. The port assembly includes a body and a port cover. The body is receivable in the opening and has a substantially axial opening therethrough. The axial opening allows access to the interior of the transformer through the port. The port cover is disposed on the interior of the transformer and is movable relative to the body between a sealed position sealing the axial opening and an open position allowing access to the interior of the temperature well. The port cover is biased toward the sealing position and moves to the open position upon being acted upon by an elongate tool inserted into the temperature well through the axial opening in the port.

### BACKGROUND OF THE INVENTION

1. Technical Field

This invention relates to ports. More specifically, the invention relates to self-sealing ports for use in connection with transformers, to allow items such as probes or other measuring devices to be selectively inserted into a well of the transformer.

2. Description of Related Art

Electrical equipment, particularly medium-voltage or high voltage electrical equipment, requires a high degree of electrical and thermal insulation between its components. Accordingly, it is well known to encapsulate components of electrical equipment, such as coils of a transformer, in a containment vessel and to fill the containment vessel with a fluid. The fluid facilitates dissipation of heat generated by the components and can be circulated through a heat exchanger to efficiently lower the operating temperature of the components. The fluid also serves as electrical insulation between components or to supplement other forms of insulation disposed around the components, such as cellulose paper or other insulating materials. Any fluid having the desired electrical and thermal properties can be used. Typically, electrical equipment is filled with oil, such as castor oil, mineral oil, or vegetable oil, or synthetic “oil,” such as chlorinated diphenyl or silicone.

Often, electrical equipment is used in a mission-critical environment in which failure can be very expensive, or even catastrophic, because of a loss of electric power to critical systems. In addition, failure of electrical equipment ordinarily results in a great deal of damage to the equipment and to surrounding equipment, thus requiring replacement of expensive equipment. Such failure can also cause injury to personnel due to electric shock, fire, or explosion. It is desirable to monitor the status of electrical equipment to predict potential failure of the equipment through detection of incipient faults and to take remedial action through repair, replacement, or adjustment of operating conditions of the equipment. However, the performance and behavior of fluid-filled electrical equipment inherently degrades over time. Faults and incipient faults should be distinguished from normal and acceptable degradation.

A known method of monitoring the status of fluid-filled electrical equipment is to monitor various parameters of the fluid. For example, the temperature of the fluid and the concentration of various gases in the fluid is known to be indicative of the operating state of fluid-filled electrical equipment. Therefore, monitoring these parameters of the fluid is used to maintain long life of the transformer. For example, it has been found that carbon monoxide and carbon dioxide increase in concentration with thermal aging and degradation of cellulosic insulation in electrical equipment. Hydrogen and various hydrocarbons (and derivatives thereof such as acetylene and ethylene) increase in concentration due to hot spots caused by circulating currents and dielectric breakdown such as corona and arcing. Concentrations of oxygen and nitrogen indicate the quality of the gas pressurizing system employed in large equipment, such as transformers. Accordingly, “dissolved gas analysis” (DGA) has become an industry-accepted method of discerning incipient faults in fluid-filled electric equipment so as to maintain long life of the equipment.

In conventional DGA methods, an amount of fluid is removed from the containment vessel of the equipment through a drain valve. The removed fluid is then subjected to testing for dissolved gas in a lab or by equipment in the field. This method of testing is referred to herein as “offline” DGA. Since the gases are generated by various known faults, such as degradation of insulation material or other portions of electric components in the equipment, turn-to-turn shorts in coils, overloading, loose connections, or the like, various diagnostic theories have been developed for correlating the quantities of various gases in fluid with particular faults in electrical equipment in which the fluid is contained.

However, since conventional methods of DGA require removal of fluid from the electric equipment, these methods do not 1) yield localized position information relating to any fault in the equipment or 2) account for spatial variations of gases in the equipment. Moreover, off-line DGA does not provide real time data relating to faults. If analysis is conducted off site, results may not be obtained for several hours or days. Incipient faults may develop into failure of the equipment over such a period of time.

For example, the measurement of hydrogen gas in the oil of an electrical transformer is of interest as it is an indication of the breakdown of the oil caused by overheating and/or arcing inside the transformer. Other properties of the oil, such as temperature, are also of interest.

In large transformers hydrogen sensors use gas chromatography or photo-acoustic spectroscopy to determine the concentration of various gases within a transformer's oil. Such devices are very expensive and the expense is not justified for smaller transformers. There are many older, small transformers that could be monitored if a low-cost method of doing so was available.

Other, lower-cost gas monitors, such as the Hydran™ M2 manufactured by General Electric Company, also are in use. This monitor senses combustible gases and then uses formulas to estimate the amounts and types of gases making up the combustible gases.

An article “Overview of Online Oil Monitoring Technologies” by Tim Cargol at the Fourth Annual Weidmann-ACTI Technical Conference, San Antonio 2005 provides a discussion of oil gas measuring techniques, including hydrogen measurement.

Yet another method of determining breakdown of transformer fluid is through partial discharge monitoring. In this method, sensors, such as UHF couplers, are placed in the oil in a transformer. These sensors detect partial discharge signals and those signals are used to monitor, detect, alarm, and/or analyze partial discharge events.

There is a need for a low-cost method of determining properties of oils, such as in electric power generation and transmission and distribution equipment, especially transformers. There is a particular need for a method and apparatus for mounting sensors or other measuring devices and/or for inserting probes into electric power generation transmission and distribution equipment that does not require taking the equipment out of service and preferably uses existing fittings or ports in the equipment without the necessity of making new openings in the housings for the equipment. It would be particularly advantageous to provide a method and apparatus for inserting a measurement apparatus into a well of a transformer or the like using an existing port.

### SUMMARY OF THE INVENTION

The present invention remedies the foregoing needs in the art by providing an improved port assembly receivable in an existing opening in a transformer to allow for selective insertion and removal of measuring tools, such as probes and/or sensors into the transformer.

In one aspect, a port assembly is receivable in an opening allowing access to the interior of a transformer. The opening may be formed in a temperature well cover or may be any opening allowing access to an inner volume. The port assembly includes a body and a port cover. The body is receivable in the opening and has a substantially axial opening therethrough. The axial opening allows access to the interior of the transformer through the port. The port cover is disposed on the interior of the temperature well and is movable relative to the body between a sealed position sealing the axial opening and an open position allowing access to the interior of the temperature well. The port cover is biased toward the sealing position and moves to the open position upon being acted upon by an elongate tool inserted into the temperature well through the axial opening in the port.

In another aspect of the invention, a transformer includes a temperature well, a temperature well cover having at least one temperature well cover opening allowing access to the interior of the temperature well and a port assembly. The port assembly includes a body disposed in the temperature well cover opening and having an axial opening therethrough, a flange disposed on the body, and a cover movable between a sealing position sealing the axial opening in the body and an open position allowing passage through the axial opening of the body into the interior of the temperature well, the cover contacting the flange in at least the sealed position.

These and other features, aspects and embodiments of the invention will be better understood with reference to the appended drawing figures and following detailed description of the invention in which preferred embodiments of the invention are shown and described.

### BRIEF DESCRIPTION OF THE DRAWING FIGURES

FIGS. 1A and 1B are perspective views of a conventional cover for a well such as a temperature well in an electric transformer.

FIG. 1C is a cross-sectional view of the cover of FIGS. 1A and 1B, taken along section line 1C in FIG. 1B.

FIG. 2A is a perspective view of a port assembly according to one preferred embodiment of the invention.

FIGS. 2B and 2C are cross-section views of the port assembly of FIG. 2A with a measuring tool inserted through the assembly and the measuring tool removed, respectively.

FIG. 3A is a perspective view of a port assembly according to one preferred embodiment of the invention.

FIGS. 3B and 3C are cross-section views of the port assembly of FIG. 3A with a measuring tool inserted through the assembly and the measuring tool removed, respectively.

FIG. 4 is a cross-section view of a port assembly according to another embodiment of the invention.

FIG. 5A is a perspective view of a port assembly according to one preferred embodiment of the invention.

FIGS. 5B and 5C are cross-section views of the port assembly of FIG. 3A with a measuring tool removed and the measuring tool inserted through the assembly, respectively.

### DETAILED DESCRIPTION OF THE INVENTION

As noted above, this invention generally relates to transformers, and more specifically to the insertion and removal of measuring devices into and from wells or inner volumes within transformers for purposes of testing various properties within the transformer.

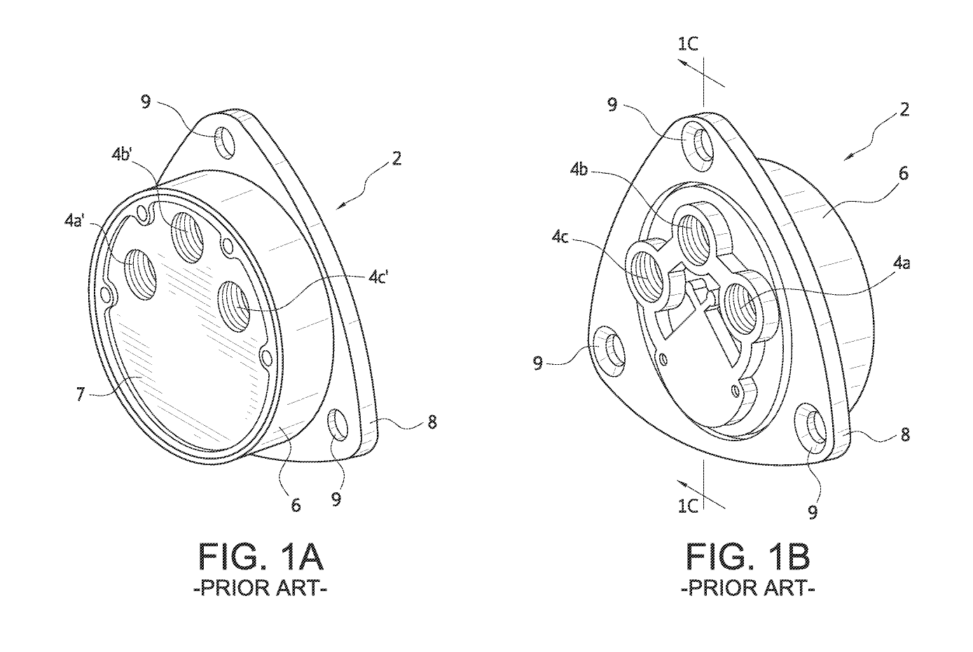

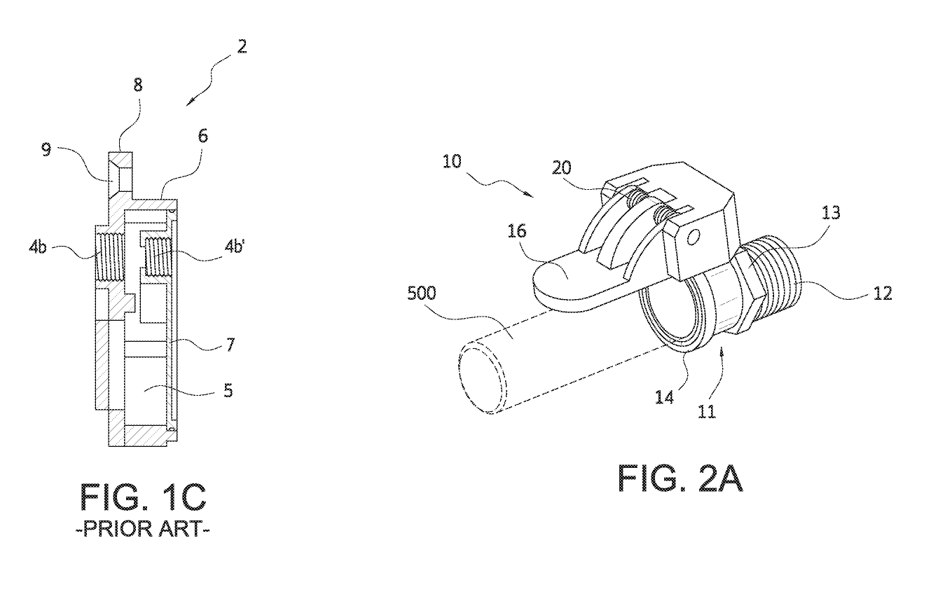

FIG. 1 shows a conventional transformer well cover 2 having a standard shape and size. The following discussion will be with reference to a conventional transformer well cover, but the invention is not limited to this use. As will be appreciated from the following disclosure, port assemblies according to the invention may be used in an opening through which it is possible to achieve access to an inner volume. The opening may be disposed in any type of cover or flange for example, or it may be in a sidewall.

The transformer well cover 2 includes three threaded holes 4a, 4b, 4c, a stepped portion 6 and a generally triangular base sized to provide a flange 8. The stepped portion 6 may be separable from the flange 8, for example, to attach the plate in a conventional manner. Each of the holes 4a, 4b, 4c is threaded, and in a conventional operation, probes or other testing or measurement devices are selectively threadably received in any of the ports 4a, 4b, 4c. The holes are threaded from the inside of the transformer out, which means it is necessary to remove either all of the cover 2 or the stepped portion 6 such that the testing devices can be threadably received in the holes 4a, 4b, 4c.

The cover 2 also includes a shield 7 that is selectively removable from the stepped portion 6, to allow access in to a volume 5 defined by the stepped portion 6 and the base. The shield 7 is retained in the stepped portion 6 to seal the volume 5. The shield 7 also includes threaded holes 4a′, 4b′, 4c′, which are aligned with the threaded holes 4a, 4b, 4c in the base.

In operation, the flange 8 contacts an inner wall of a transformer well (not shown), and is affixed to the inner wall via through holes 9. Accordingly, the stepped portion 6 and the shield 7 are presented to a user, outside the well. Plugs (not shown) are conventionally provided in the base threaded holes 4a, 4b, 4c and/or the shield threaded holes 4a′, 4b′, 4c′ to ensure that an increase in pressure in the well will not result in expulsion of oil or other contents form the well. In one instance in which it is desirable to access the interior of the well, the plugs an'/or the shield 7 are removed, and access may be achieved through the threaded well cover openings 4a, 4b, 4c.

As noted above, various embodiments of the present invention provide an alternative to the conventional method of removing all or a portion of the cover 2 to insert probes or other measurement devices into the well covered by the cover 2.

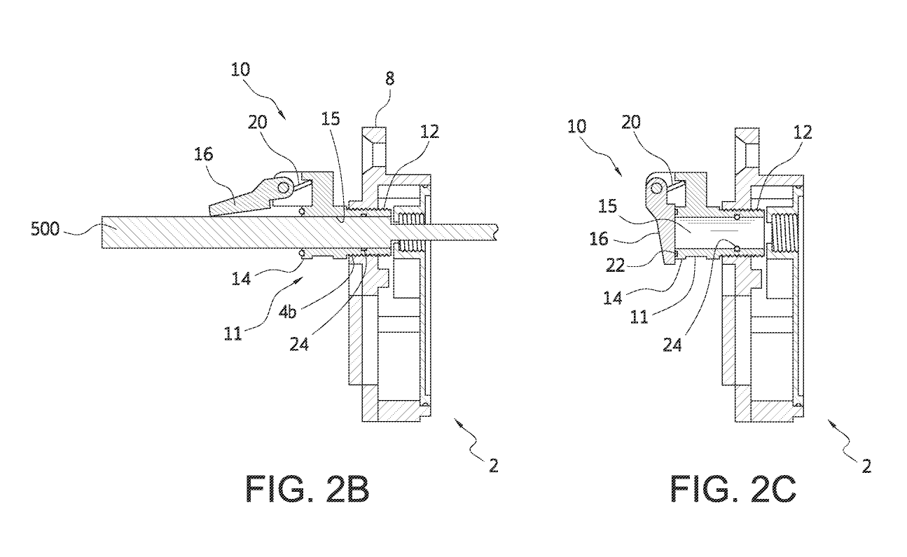

A first embodiment of the invention is illustrated in FIGS. 2A-2C. There, a port assembly 10 is illustrated as threadably received in opening 4b of the cover 2. Preferably, a port assembly 10 is disposed in any of or all of the holes 4a, 4b, 4c before the cover is fixed to the transformer.

As illustrated, the port assembly 10 includes a generally cylindrical body 11 having a threaded end 12 and a flange 14. The threaded end 12 is sized for threadable reception in at least one of the holes 4a, 4b, 4c, such that the port assembly 10 is threadably received in the respective opening. To facilitate this threaded attachment, a working feature 13 is provided along the body that is sized and shaped to be acted upon by a conventional tool. In the illustrated embodiment, the working feature 13 is hexagonal in shape such that a wrench or other conventional device can be used to thread the port assembly 10 into and out of the opening 4a, 4b, 4c.

The flange 14 is disposed on a distal end of the body 11, and thus is spaced from the flange 9 of the cover 2, into the transformer well. That is, when the cover 8 is applied to the transformer, the flange is disposed inside the sealed well of the transformer. An opening 15 (best seen in FIG. 2C) runs axially through the body 11 and allows communication through the port assembly 10, i.e., communication between the inside of the well and the ambient atmosphere.

The port assembly 10 further includes a cover 16 that is moveable relative to the body 11, to selectively seal the opening 15 through the body 11. In the illustrated embodiment, the cover 16 is attached to the body 11 by a mechanism including a torsion spring 20. The torsion spring 20 is selected to bias the cover 16 against the body 11 to maintain a seal over the opening 15. In the illustration, a seal 22, such as a polymeric seal, is provided on the flange 14 of the body 11. The seal 22 surrounds the opening 15 at the body 11 of the port assembly 10 and is contacted by the cover 14 when the cover 16 is in contact with the body 11. More specifically, the seal 22 contacts the cover 16 to create a seal, prohibiting passage through the opening 15. As illustrated, the flange 14 may have an indention or similar receptacle for receiving the seal 22. In one preferred embodiment, the flange 14 includes an annular indentation configured to accept and retain therein an annular seal 22, similar to a conventional O-ring.

In an alternative embodiment the cover 18 may include a protrusion protruding from the cover that is sized to be received in the opening 15 when the cover seals the opening 15. The seal 22 may be disposed on a radially outward face of the stepped portion, for contacting an inner surface of the opening 15 in this alternative embodiment. In such an embodiment, the seal may be similar to a conventional wiper seal. In other embodiments, both the illustrated seal 22 and a wiper seal disposed on a protrusion of the cover 18 may be used to ensure a proper seal.

As also illustrated in FIGS. 2A-2C, a seal 24 also is provided in the opening 15. This seal will contact an outer surface of an elongate tool 500 inserted into the opening 15.

The spring 20 is chosen to have sufficient force to tightly force and retain the cover 16 against the body 11, thereby effectuating a seal over the opening 15 that prevents any fluid in the well from exiting through opening 15. However, the closing force of the spring 20 may be overcome by pressing against the cover 16, through the opening 15. More specifically, a user may insert a probe or other elongate tool 500 into the opening 15 to contact the cover 16. As the tool 500 is continuously pushed with sufficient force, the cover 16 will act against the bias force of the spring 20 and the continued insertion of the tool 500 will open the cover 16 completely allowing for full insertion of the probe into the well. In the illustrated embodiment, and shown specifically in FIGS. 2A and 2B, the cover 16 rests on a side of the tool 500 when the tool is fully inserted into the opening 15.

When a user desires to withdraw the tool 500 from the well, the biasing force of the spring 20 acts to automatically close the cover 16, thereby resealing the opening 15 upon removal.

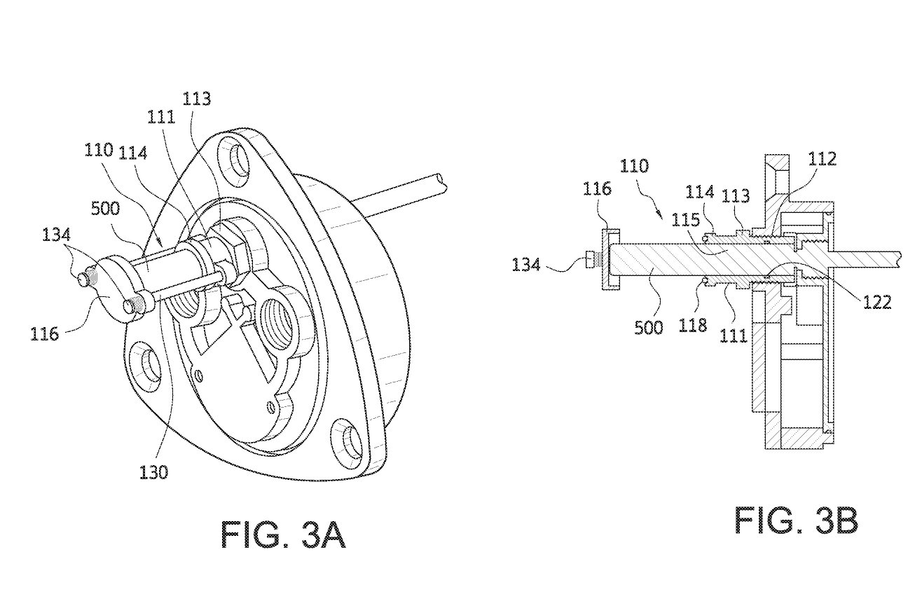

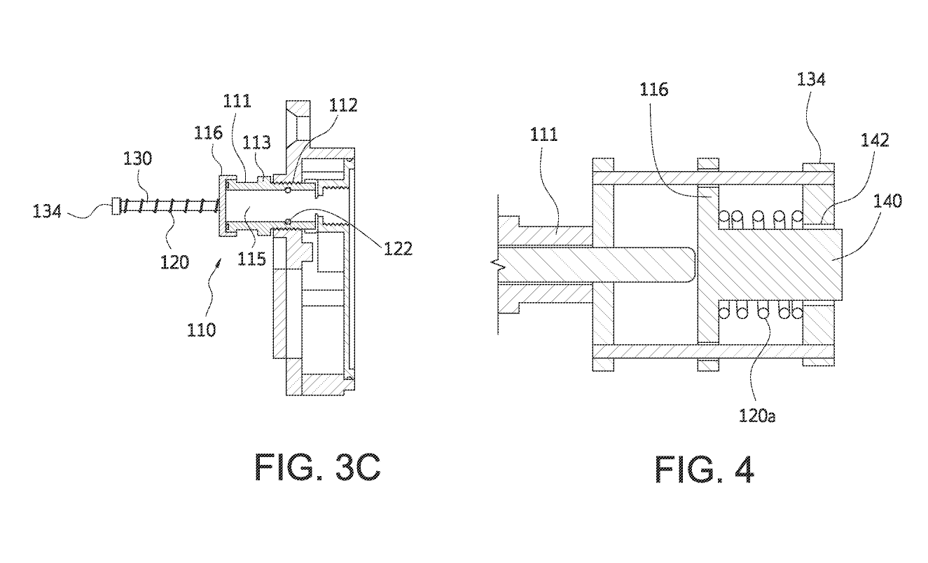

Another embodiment of the invention is illustrated in FIGS. 3A and 3B. There, an alternative port assembly 110 is illustrated. The port assembly 110 includes a body 111 similar to the body 11 of FIGS. 2A-2C and a cover 116.

The body 111 is substantially the same as the body 11 described above. It includes a threaded end 112, a working feature 113, and a flange 114. An opening 115 runs axially through the body 111.

Like the cover 16 discussed above, the cover 116 is disposed to move relative to the body 111 between a sealing position contacting the flange 114 (and therefore covering the opening 115) and an open position spaced from the flange 114. As with the embodiment described above, the cover 116 is biased to the sealing position and moves to the open position only upon being acted upon by an outside force.

To facilitate controlled movement between the sealing position and the open position, the port assembly 110 further includes a pair of guide posts 130 extending in a direction opposite the threaded end 112. The posts 130 are aligned parallel to the opening 115. The cover 116 includes a pair of holes that are sized to receive the guide posts 130. Specifically, the holes are sized to provide a clearance fit with the guide posts 130, such that the cover 116 is free to slide relative to the flange 114, on the posts 130. Stops 134, which have a larger diameter than the posts 130 and the holes in the cover 116, are fixed proximate the distal ends of the posts 130, to retain the cover 118 on the posts 130. Two stops 134, one for each guide post, are illustrated, but in other embodiments, a single stop, spanning between both guide posts may be provided. Additional configurations may also be contemplated by one having ordinary skill in the art, without departing from the spirit and scope of the invention.

One or more springs 120 are disposed to bias the cover 118 toward the flange 112. In the illustrated embodiment, the springs 120 are helical springs, each circumscribing one of the posts 130. One end of each of the springs 120 contacts one of the stops 134 and the other contacts the cover 116. The springs 120 are selected to have sufficient size and stiffness that absent any other force, they will bias the cover 118 against the flange 112, to seal the opening 115.

As with the embodiment described above with relation to FIGS. 2A and 2B, the port assembly 110 is threaded into a hole in a transformer cover, such as one of holes 4a, 4b, 4c in FIG. 1. When a user desires to access the inner cavity of the transformer, he inserts a probe or other device into the opening 115 in the body 111 and applies sufficient force on the cover 116 to compress the springs 120, thereby moving the cover 116 away from the flange 112. The probe is thus inserted into the well.

Like the embodiment shown in FIGS. 2A and 2B, the cover 116 also preferably is provided with a seal 120. The seal may be disposed anywhere it will be effective at sealing the opening 115 when the cover 116 is contacting the flange 114. In the illustrations, the seal 120 is provided around the opening 115 on the flange 114. It could alternatively be provided on the cover 116, or the seal may be disposed in the opening, or on a protrusion from the cover 118 for contacting an inner surface of the opening 115. A seal 122 also is provided on the inner surface of the opening, which may create a seal with a tool 500 inserted via the opening 115.

Modifications to this embodiment are contemplated. For example, FIG. 4 illustrates a similar example, but in which a protrusion 140 extends from a side of the cover 116 opposite the body 111. A stop 134 extends between the guide post 130 and a cutout 142 is provided in the stop 134, such that the protrusion forms a clearance fit with the cutout 142. In this embodiment, a single spring 120a is disposed about the protrusion 140, with one end contacting the cover 116 and the other end contacting the stop 134.

Operation of the cover relative to the body 111 is identical to that of the cover just described, with the spring 120a biasing the cover to the sealing position and an opposite force being applied through the opening 115 to move the cover away from the body 111. This embodiment requires only a single spring, but still benefits from the alignment provided by the guide posts. Other modification also may be made. For example, more guide posts may be provided or in another similar embodiment a single guide post may be provided. It should also be readily understood by those having ordinary skill in the art that features described in other embodiments may also be incorporated into this embodiment.

Thus, although the principle behind the embodiments of FIGS. 2-4 is similar, the embodiments of FIGS. 3A-3C and 4 provide a more uniform pressure. The guide posts 130 and co-axial spring(s) 120 theoretically remove any angular forces that may act on the tool 500, when inserted; the cover only contacts a tip of the tool 500. In FIG. 2, by contrast, the cantilevered cover contacts a side of the tool, which may damage the tool 500.

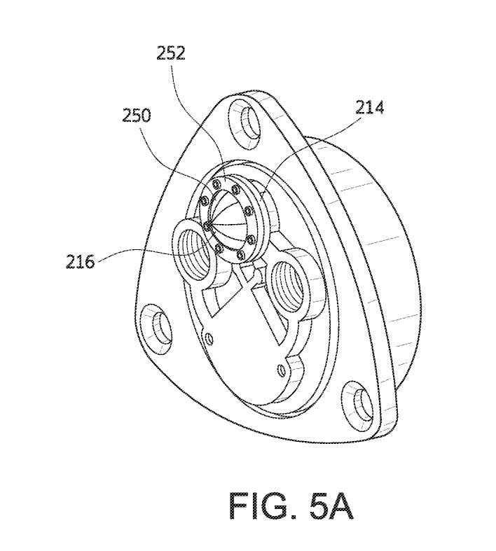

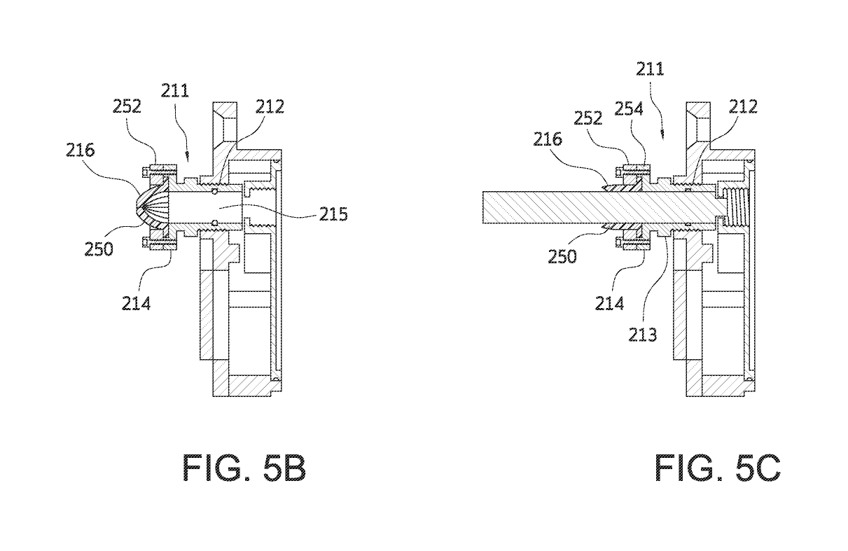

FIG. 5 shows another embodiment of the invention, in which a cover 216 is disposed over an opening 215 through a body 211, which body 211 is substantially identical to the bodies 11, 111, described above. The body 211 includes a threaded end 212, a working feature 213, and a flange 214 depending outwardly. The opening 215 passes axially through the body 211.

In this embodiment the cover is a polymeric seal 250, which is fixed at its periphery to the flange 214. Specifically, an annular ring 252 is disposed on a side of the seal 250 opposite the flange 214 such that the seal 250 is retained between the flange 214 and the ring 252. This may be accomplished in any number of ways. For example, the ring 252 may be bolted to the flange 214 using conventional screws or bolts, in which case the flange 214 has a pattern of threaded holes and the ring 252 has a complimentary pattern of through holes (or vice versa). The seal 250 could be pinched between the ring 252 and the flange 214, or the seal may include through holes proximate its periphery matching the pattern of threaded holes, and through which the screws or bolts pass when threaded into the flange 214. In the illustrations, the flange 214 includes a step 254 that accommodates the thickness of the peripheral edge of the seal 250.

The polymeric seal 250 is specially designed to act like a self-sealing, one-way wiper seal. The inner portion of the seal 250 is movable relative to its fixed outer periphery, and thus relative to the flange, to selectively seal and open the axial opening 215. That is, the seal comprises a contiguous skirt that folds on itself to seal the opening. When a probe is inserted into the opening 215 and presses against the seal, the skirt opens into the well (as is illustrated in FIG. 5C), allowing for axial pass-through of the probe. As the probe passes the skirt, the skirt maintains sealing contact with the sides of the probe, because it is biased toward the sealed position. When the probe is removed, the skirt seals back on itself, thereby sealing the opening.

In the illustration of FIGS. 5A-5C, the seal is preferably slightly conical in the sealed position. In this manner, the skirt will only open into the well; it will interfere with itself, and thus seal tighter if some pressure is applied in the opposite direction, such as an increased pressure in the well.

The foregoing embodiments of the present invention are provided as exemplary embodiments. Modifications of these embodiments will be readily apparent to those having ordinary skill in the art. The invention is not intended to be limited by the foregoing embodiments, but instead is intended to be limited only by the appended claims.

1. A port assembly receivable in an opening, the opening allowing access to an internal volume of a transformer, the port assembly comprising:
a body receivable in the opening and having a substantially axial opening therethrough, the axial opening allowing access to the internal volume through the port; and
a port cover disposed in the volume and movable relative to the body between a sealed position sealing the axial opening and an open position allowing access to the internal volume,
wherein the port cover is biased toward the sealing position and moves to the open position upon being acted upon by a measuring device inserted into the volume through the axial opening in the port.

2. The port assembly of claim 2, further comprising a flange extending radially outwardly from the body and circumscribing the axial opening.

3. The port assembly of claim 1, further comprising a spring cooperating with the port cover to bias the port cover to the sealed position.

4. The port assembly of claim 3, wherein the spring is a torsion spring.

5. The port assembly of claim 4, wherein the cover rotates relative to the body, about an axis of the torsion spring.

6. The port assembly of claim 3, wherein the spring comprises at least one helical spring.

7. The port assembly of claim 6, further comprising a stop spaced from the body, the spring being disposed between the cover and the stop to bias the cover away from the stop, toward the body.

8. The port assembly of claim 7, further comprising one or more guide rails extending away from the body in a direction generally parallel to the axial opening, the cover being configured to slide along the guide rails between the sealing position and the open position.

9. The port assembly of claim 8, wherein the spring is disposed on one of the guide rails.

10. The port assembly of claim 1, wherein the cover is a polymeric seal.

11. The port assembly of claim 10, the polymeric seal comprising a contiguous skirt.

12. The port assembly of claim 10, wherein the contiguous skirt is substantially conical, with a vertex spaced inward from the body.

13. The port assembly of claim 12, wherein the contiguous seal includes an axial opening through which an elongate tool can be passed upon being pressed through the axial opening with sufficient force.

13. The port assembly of claim 10, further comprising an annular ring disposed to fixedly retain the outer periphery of the polymeric seal against the body.

14. The port assembly of claim 1, wherein the opening is formed in a cover.

15. The port assembly of claim 14, wherein the cover is a temperature well cover.

16. A transformer comprising:
a sidewall defining an internal volume and having at least one opening therethrough allowing access to the internal volume; and
a port assembly, the port assembly comprising:
a body disposed in the opening and having an axial opening therethrough,
a flange disposed on the body, and
a cover movable between a sealing position sealing the axial opening in the body and an open position allowing passage through the axial opening of the body into the interior of the temperature well, the cover contacting the flange in at least the sealed position.

17. The transformer of claim 16, further wherein the body is introduced into the opening from a side of the opening proximate the interior of the temperature well.

18. The transformer of claim 17, wherein the opening includes a threaded hole and the body is threaded into the threaded hole.

19. The transformer of claim 16, wherein the cover is moved to the open position upon insertion of an elongate tool into the axial opening that contacts the cover with sufficient force to move the cover to the open position.

20. The transformer of claim 19, wherein the cover is biased to the sealing position and returns to the sealing position upon removal of the elongate tool from the axial opening.

21. The transformer of claim 20, further comprising a spring biasing the cover to the sealed position.

22. The transformer of claim 21, wherein the cover comprises a contiguous polymeric skirt.

23. The transformer of claim 16, wherein the opening is formed in a cover.

24. The transformer of claim 23, wherein the cover is a temperature well cover.
